(19) United States
(12) Patent Application Publication
(10) Pub. No.: US 2009/0155627 A1
(43) Pub. Date: Jun. 18, 2009

(54) DISCRETE TRACK MEDIA WITH A CAPPED MEDIA STRUCTURE HAVING HIGH MOMENT AND EXCHANGE

(75) Inventors: Andreas Klaus Berger, Donostia (ES); Eric Edward Fullerton, Morgan Hill, CA (US); Byron Hassberg Lengsfield, III, Gilroy, CA (US); James Terrence Olson, Santa Cruz, CA (US)

Correspondence Address: BRACEWELL & GIULIANI LLP, PO BOX 61389, HOUSTON, TX, 77208-1389, US

(73) Assignee: Hitachi Global Storage Technologies Netherlands B.V., Amsterdam (NE)

(21) Appl. No.: 11/956,389

(22) Filed: Dec. 14, 2007

(51) Int. Cl. G11B 5/62; G11B 5/84

(52) U.S. Cl. 428/828

(57) ABSTRACT

A media architecture is optimized for discrete track recording. A capped or exchange-spring media uses a thin media structure and incorporates higher moment density magnetic layers. A thin exchange coupling layer is used in conjunction with a cap layer to control the reversal mechanism and exchange. Thus, the exchange coupling layer mediates the interaction between the two outer magnetic layers. The thickness of the exchange coupling layer is tuned by monitoring the media signal-to-noise ratio, track width and bit error rate. The recording performance is enhanced by tuning the intergranular exchange in the system through the use of the high-moment cap as writeability, resolution and noise are improved.

### BACKGROUND OF THE INVENTION

1. Technical Field

The present invention relates in general to discrete track media and, in particular, to an improved system, method, and apparatus for discrete track media having a capped media structure with high moment density and exchange.

2. Description of the Related Art

Various forms of exchange-spring and/or capped media have been described for longitudinal media. More recently, this class of media has been the basis of perpendicular recording systems. The basic structure is a granular media layer (CoPtCrB for longitudinal media and CoPtCr-oxide for perpendicular media) that is coupled to a soft layer with relatively strong intergranular exchange. The two layers are either directly exchange coupled (i.e., capped) or the interaction is mediated through a thin exchange coupling layer (i.e., weak-link media).

There are a number of media parameters that may be optimized in an attempt to improve the performance of the recording system. In perpendicular recording systems utilizing continuous media, CPM, the capping structure contributes to many, often contradictory, aspects of recording performance. For example, on-track performance can be improved by increasing the exchange interaction between grains, but this improvement often comes at the expense of a broadening of the write width which limits available track density. The nature of the capping material also plays an important role in determining both the write field needed to store the data and the resolution that can be achieved when one attempts to read-back the data.

For perpendicular recording the advantages of the two-layer structure are well established. The main advantages are improved writeability, stability and media noise (principally, transition position jitter) when compared to a single layer granular media. The main disadvantage is relatively poor resolution and, for some cases, increased written track width. Various types of solutions using coupling layers are also known, such as those described in U.S. Patent Application Publication No. 2006/0177704. Although these solutions are workable in the context of discrete track recording, an improved solution that overcomes the limitations of the prior art would be desirable.

### SUMMARY OF THE INVENTION

Embodiments of a discrete track recording system, method, and apparatus for improving the properties of capped or exchange-spring media utilize a thin media structure and incorporate higher moment density magnetic layers. A thin exchange coupling layer is used in conjunction with a capping layer to control the reversal mechanism and exchange. Non-magnetic patterned grooves separate the written tracks and control the track-pitch of the system.

For example, one embodiment comprises a magnetic granular storage layer, a cap layer having a high moment exchange-coupled layer, and an exchange coupling layer that mediates the interaction between the two magnetic layers. The thickness of the exchange coupling layer is tuned by monitoring the media signal-to-noise ratio, track width and bit error rate. The balance of on-track and off-track performance is one aspect of any successful media design. In one embodiment, the recording performance is enhanced by use of a high-moment cap as writeability, resolution and noise are improved. Similar behavior is observed in micromagnetic modeling of capped media.

In recording systems employing continuous perpendicular media, capped or weak-link media are used with a soft cap layer. This media is easy to write, exhibits high thermal stability and good on-track performance. In these systems the off-track performance is limited by the fact that the fields used to write data on an adjacent track can partially erase the data on a nearby track.

In discrete track media, non-magnetic patterned grooves separate the written tracks. Due to the presence of these non-magnetic grooves, the exchange interaction between adjacent tracks is broken. The track width is limited by the lithography, while the on-track performance is separately optimized. For a capped media, high inter-granular exchange plays an important role in the writing process. The reversal is closer to domain-wall propagation than the reversal of individual gains by the field, which significantly improves the closure field for high anisotropy media. The broadening of the track is facilitated by the written region at the track center that broadens with field. By breaking the exchange interaction between the tracks the domain propagation is confined to the data track directly beneath the write pole. If there is an insufficient field to nucleate reversal on the adjacent track (which tends to be at higher fields than wall propagation), then a much higher track density can be achieved in discrete track media than in continuous media.

The foregoing and other objects and advantages of the present invention will be apparent to those skilled in the art, in view of the following detailed description of the present invention, taken in conjunction with the appended claims and the accompanying drawings.

### BRIEF DESCRIPTION OF THE DRAWINGS

So that the manner in which the features and advantages of the present invention, which will become apparent, are attained and can be understood in more detail, more particular description of the invention briefly summarized above may be had by reference to the embodiments thereof that are illustrated in the appended drawings which form a part of this specification. It is to be noted, however, that the drawings illustrate only some embodiments of the invention and therefore are not to be considered limiting of its scope as the invention may admit to other equally effective embodiments.

FIG. 1 is a schematic diagram of one embodiment of a media structure constructed in accordance with the invention;

FIG. 2 is a plot of coupling layer thickness and signal-to-noise ratio;

FIG. 3 is a plot of coupling layer thickness and bit error ratio;

FIG. 4 is a plot of coupling layer thickness and write width;

FIG. 5A depicts the written track width for continuous media;

FIG. 5B depicts the expected written discrete track media pattern;

FIG. 5C depicts a highly exchange-coupled media where track width is limited to the patterned track, and is constructed in accordance with the invention; and

FIG. 6 is a schematic diagram of another embodiment of a media structure constructed in accordance with the invention.

### DETAILED DESCRIPTION OF THE INVENTION

Embodiments of a discrete track recording system, method, and apparatus for improving the resolution and other properties of capped or exchange-spring media, thin the media structure by incorporating higher moment density magnetic layers. A significantly thinner media structure may be used in conjunction with an exchange coupling layer and a cap layer to control the reversal mechanism and exchange. Non-magnetic patterned grooves break the exchange interaction between the magnetic material comprising the data tracks. This physical separation of the written tracks controls the track-pitch of the system.

In recording systems employing continuous perpendicular media, capped or weak-link media are used with a soft cap layer that is easy to write, exhibits high thermal stability and good on-track performance. In these systems the off-track performance (i.e., track-width) is limited by the fact that the fields used to write data on an adjacent track can partially erase the data on a nearby track.

In discrete track media, non-magnetic patterned grooves separate the written tracks. Due to the presence of these non-magnetic grooves, the exchange interaction between adjacent tracks is broken. The track width is limited by the lithography, while the on-track performance is separately optimized. The exchange interaction should be suppressed between the tracks. For a capped media, the high inter-granular exchange plays an important role in the writing process. The reversal is closer to domain-wall propagation than the reversal of individual gains by the field. This significantly improves the closure field for high anisotropy media.

The broadening of the track is facilitated by the written region at the track center that broadens with field. Breaking the exchange interaction between the data tracks limits domain type propagation to reversal of the magnetic media directly under the write pole. If there is not sufficient field to nucleate reversal in the adjacent track (which tends to be at higher fields than wall propagation) then a much higher track density can be achieved in discrete track media than in continuous media.

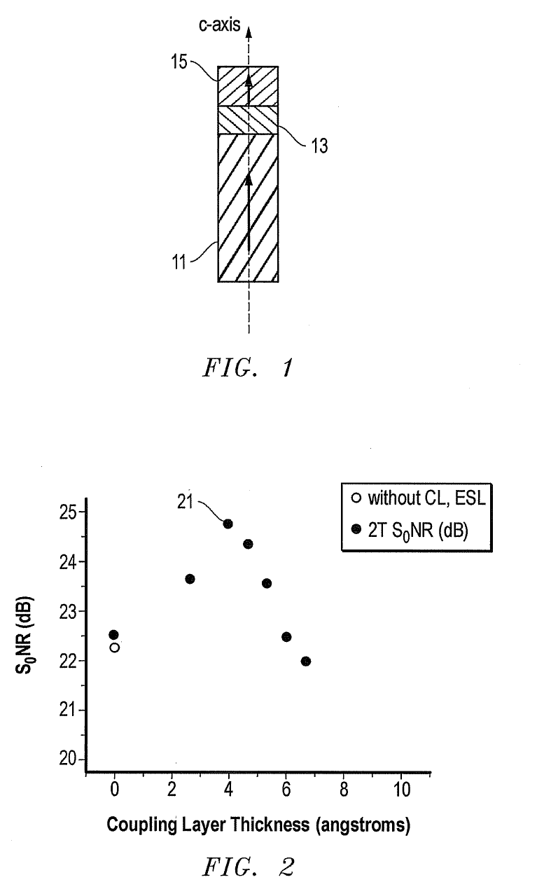

An example of the invention is shown schematically in FIG. 1 (not to scale). In one embodiment, the media comprises a magnetic layer 11 having a thickness in a range of about 6 to 18 nm. In other embodiments the magnetic layer 11 has a thickness of about 8 to 14 nm. The magnetic layer 11 may be formed from an alloy containing CoPtCrTaO, CoPtCrSiO, etc. These layers also may contain boron or other non-metallic segregants. However, in some embodiments, a dual-layer magnetic layer 11 has advantages. For example, the magnetic layer 11 may comprise a 6 nm layer of CoPtCrTaO, topped by a 7 nm layer of CoPtCrSiO. In dual-layer designs, the total thickness of the magnetic layer falls within the ranges described above.

In one embodiment, an exchange coupling layer 13 is formed on the magnetic layer 11 and has a thickness in a range of about 0.2 to 3 angstroms. In some embodiments the exchange coupling layer 13 has a thickness of about 0.5 to 1.2 angstroms. The exchange coupling layer 13 also may be realized by varying the alloy composition (e.g., oxygen) at the inter-layer interface. The exchange coupling layer 13 may be formed from alloys such as Ru₅₅Cr₁₀Co₃₅, RuCo, RuCoO, etc.

A magnetic cap layer 15 is formed on the exchange coupling layer 13. The cap layer 15 may have a thickness of up to about 14 nm. In some embodiments, the cap layer 15 has a thickness of about 3 to 7 nm. The cap layer 15 may be formed from, for example, CoPtCrB, CoCr (e.g., Co₉₀Cr₁₀), or an oxide such as CoPtCrSiO, depending on the mix of vertical to lateral exchange required for the application. The cap layer 15 also may comprise a dual-layer design as described above for the magnetic layer. In dual-layer designs, the total thickness of the cap layer falls within the ranges previously specified.

In other embodiments, the magnetic recording layer may comprise CoCrPtTiO, CoPtCrSiO, CoPtCrTaO, or other CoPtCr metallic oxides containing Cu, Nb or V; the exchange coupling layer may comprise thin layers of high chromium, CoCr, RuCo, RuCoO or Ru₅₅Cr₁₀Co₃₅; and the cap layer may comprise CoPtCrB, CoCr or Co₉₀Cr₁₀.

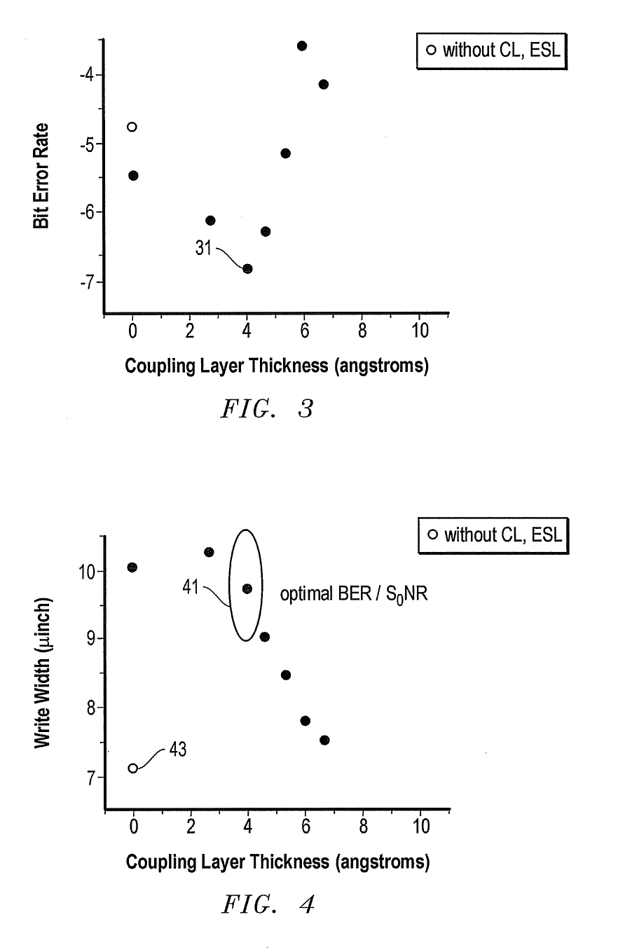

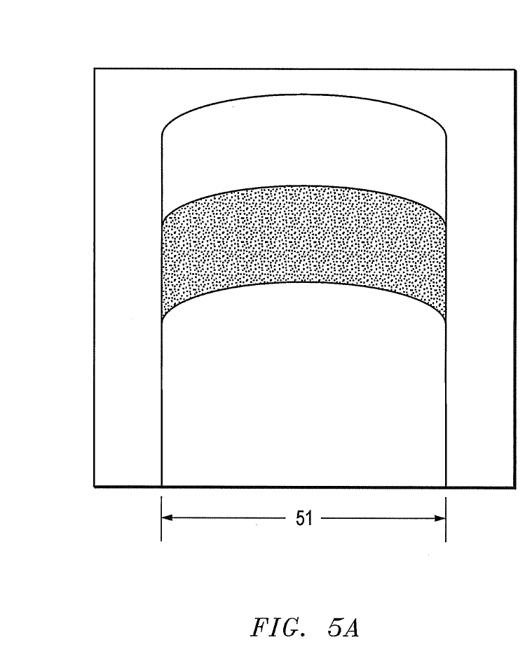

The magnetic layer 11 is the granular storage layer, the cap layer 15 is the high moment exchange-coupled layer, and the exchange coupling layer 13 mediates the interaction between the two magnetic layers 11, 15. By tuning the thickness of the exchange coupling layer 13 there is a clear optimum 21, 31 in the media signal-to-noise ratio (SNR) and bit error rate (BER). See, e.g., FIGS. 2 and 3, respectively, which depict an embodiment having an exchange coupling layer thickness of approximately 4 angstroms. In one embodiment, the increased exchange interaction resides at least partially and, in some examples, wholly in the base-oxide layer and has a thickness of about 3 angstroms.

In one embodiment, the increased exchange interaction resides at least partially and, in some examples, wholly in the base-oxide layer. Increased intergranular exchange (relative to continuous perpendicular media) is advantageous in discrete track recording (DTR), but the focus in achieving this has been in increased exchange through the cap (e.g., FIG. 2 is a high-moment cap). However, this goal also may be achieved by increasing the inter-granular exchange in the hard oxide layer (e.g. CoPtCr—TaOx), or some combination of the two parameters (e.g., exchange through the cap and exchange via the hard oxide layer).

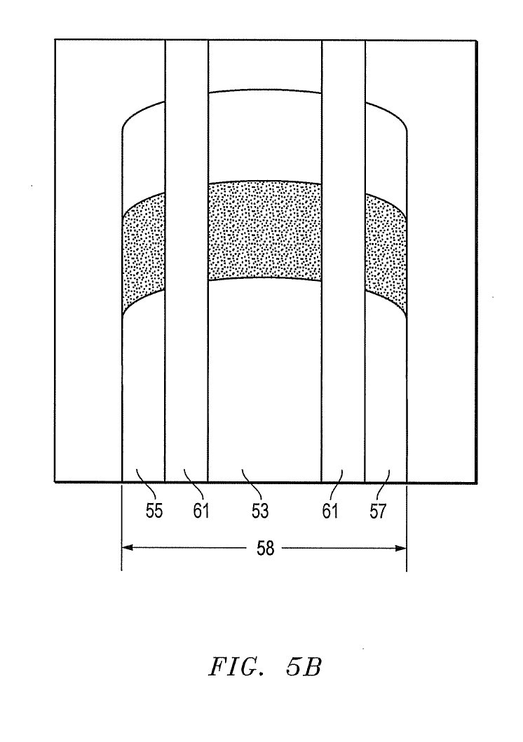

The balance of on-track and off-track (i.e., track-width) performance is one aspect of any successful media design. In one embodiment, the recording performance is enhanced by use of a high-moment cap as writeability, resolution and noise are improved. Similar behavior is observed in micromagnetic modeling of capped media. For example, the embodiment described above in FIGS. 2 and 3 shows that its write width versus coupling layer thickness (depicted in FIG. 4) provides a strong increase in the write width of the tracks for optimum coupling 41 compared to a design 43 having no coupling layer.

This behavior is distinct from what is expected for a single-layer granular media with low inter-granular exchange coupling where the reversal of the grains is dominated by the local anisotropy of the grains. The track width is dictated by the cross track field profile and the anisotropy of the grains. Thus, having a non-magnetic boundary between tracks will not allow significantly higher track densities (as least from a writing perspective).

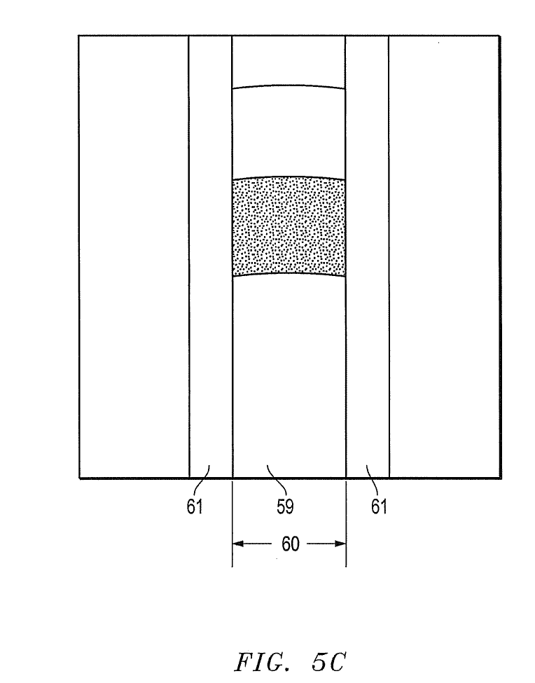

There are advantages in read-back of the signal, which are shown schematically in FIGS. 5A-C. FIG. 5A shows the written track width 51 for a continuous media, while FIG. 5B shows the expected written discrete track media pattern 53 with a single-layer granular media. The written track extends beyond the center track 53 and adversely affects adjacent tracks 55, 57.

However, for a highly exchange-coupled media (e.g., FIG. 5C) it may be expected that the written track width can be limited to a discrete center track 59. Comparing FIGS. 5A and 5B, the discrete pattern 53, 55, 57 has the same track width 58 as that of the continuous media 51. In contrast, FIG. 5C depicts a highly exchange-coupled media 59 where the track width 60 is limited to the patterned track. In FIGS. 5B and C, the white regions 61 are the areas where the magnetization has been suppressed. Such a structure allows the media and head to be optimized for on-track performance while mitigating the effects of track width broadening.

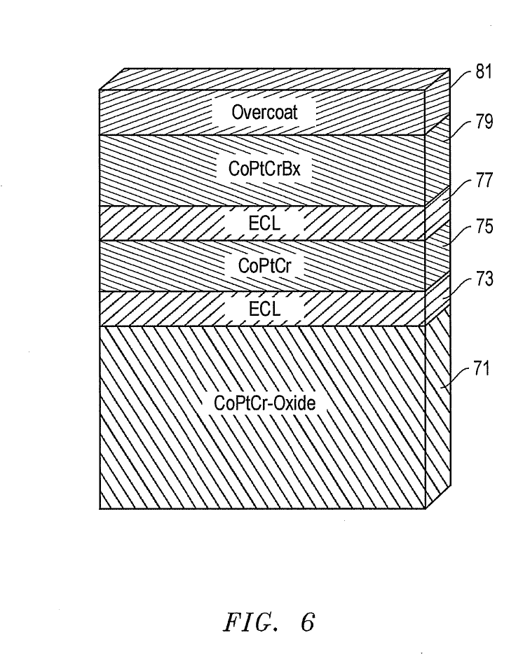

Another example of the invention is shown in FIG. 6 as a media grain having a segmented cap. In this embodiment, the material properties are separately optimized to improve media performance. The media includes a magnetic layer 71 of CoPtCr-Oxide (e.g., having a thickness of about 14 nm), a first exchange coupling layer 73, a high moment magnetic capping layer 75 comprising CoPtCr (e.g., having a thickness of about 2 nm), a second exchange coupling layer 77 (e.g., each exchange coupling layer 73, 77 having a thickness of about 0.5 angstroms), a relatively low moment capping layer 79 of CoPtCrB (e.g., having a thickness of about 2 nm), and an overcoat 81. The thickness and composition of the two capping layers 75, 79 are optimized, together with the thickness of the two exchange coupling layers 73, 77, to improve recording performance.

In still another embodiment, the invention comprises a method of forming a weak-link media structure. In one version the method includes providing a media structure having a magnetic recording layer, a cap layer and a thin interlayer boundary region between the magnetic recording layer and the cap layer; configuring the thin interlayer boundary region without an explicit exchange coupling layer; and mediating exchange coupling between the magnetic recording and cap layers by varying a composition of magnetic alloys in the thin interlayer boundary region. In this embodiment of the invention, interlayer exchange coupling is mediated by varying the oxygen composition of the hard magnetic alloy (e.g., CoPtCr-oxide) in the thin interlayer boundary region, which has a thickness of approximately 1 nm.

While the invention has been shown or described in only some of its forms, it should be apparent to those skilled in the art that it is not so limited, but is susceptible to various changes without departing from the scope of the invention.

What is claimed is:

1. A recording medium for perpendicular recording applications, comprising:
a magnetic recording layer having a surface and an axis of magnetic anisotropy substantially perpendicular to the surface;
a cap layer ferromagnetically exchange coupled to the magnetic recording layer;
an exchange coupling layer between the magnetic recording layer and the cap layer, the exchange coupling layer regulating the ferromagnetic exchange coupling between the magnetic recording layer and the cap layer, the exchange coupling layer having a nominal thickness of approximately 4 angstroms; and
the magnetic recording layer, cap layer and exchange coupling layer form a discrete track media pattern where exchange interaction between adjacent tracks thereof is suppressed.

2. A recording medium according to claim 1, wherein the magnetic recording layer and the cap layer incorporate high moment density magnetic layers.

3. A recording medium according to claim 1, wherein the magnetic recording layer is selected from the group consisting of CoCrPtTiO, CoPtCrSiO, CoPtCrTaO, and CoPtCr metallic oxides containing Cu, Nb or V, the exchange coupling layer is selected from the group consisting of CoCr, RuCo, RuCoO and RuCrCo, and the cap layer is selected from the group consisting of CoPtCrB, CoCr and CoCr.

4. A recording medium according to claim 1, wherein at least one of the magnetic layer and the cap layer is formed from a plurality of layers.

5. A recording medium according to claim 4, wherein the magnetic layer comprises a 6 nm layer of CoPtCrTaO and a 7 nm layer of CoPtCrSiO.

6. A recording medium according to claim 1, wherein the magnetic recording layer contains a non-metallic segregant.

7. A recording medium according to claim 1, wherein the non-metallic segregant is boron.

8. A recording medium according to claim 1, wherein the magnetic recording layer has a thickness of 6 to 18 nm, the exchange coupling layer has a thickness of 0.2 to 3 angstroms, and the cap layer has a thickness of no more than 14 nm.

9. A recording medium according to claim 1, wherein the magnetic recording layer has a thickness of 8 to 14 nm, the exchange coupling layer has a thickness of 0.5 to 1.2 angstroms, and the cap layer has a thickness of 3 to 7 nm.

10. A recording medium according to claim 1, wherein the magnetic recording layer has a thickness of about 13 nm, and the cap layer has a thickness of about 3 nm.

11. A recording medium according to claim 1, wherein the magnetic recording layer comprises CoPtCrO, the coupling layer comprises CoCr, and the cap layer comprises CoPtCrB.

12. A recording medium according to claim 11, wherein the capping layer is segmented into two soft magnetic layers that are coupled to each other and to a bottom, hard magnetic layer by means of exchange coupling layers, and the exchange coupling layers comprise thin layers of high Cr and CoCr.

13. A recording medium according to claim 12, wherein each of the exchange coupling layers has a thickness of about 0.5 angstroms.

14. A recording medium according to claim 1, wherein the magnetic recording layer has a thickness of about 14 nm, the exchange coupling layer has a thickness of about 3 angstroms, the cap layer has a thickness of about 2 nm, and further comprising an overcoat on the cap layer.

15. A recording medium for perpendicular recording applications, comprising:
a magnetic recording layer comprising CoPtCrTaO, the magnetic recording layer having a surface, an axis of magnetic anisotropy substantially perpendicular to the surface, and a thickness of 6 to 18 nm;
a cap layer comprising CoCr and ferromagnetically exchange coupled to the magnetic recording layer, the cap layer having a thickness of no more than 14 nm;
an exchange coupling layer comprising RuCrCo and located between the magnetic recording layer and the cap layer, the exchange coupling layer regulating the ferromagnetic exchange coupling between the magnetic recording layer and the cap layer, the exchange coupling layer having a thickness of about 0.2 to 3 angstroms; and
the magnetic recording layer, cap layer and exchange coupling layer form a discrete track media pattern where exchange interaction between adjacent tracks thereof is suppressed.

16. A recording medium according to claim 15, wherein the magnetic recording layer has a thickness of about 13 μm, and the cap layer has a thickness of about 3 nm.

17. A recording medium according to claim 15, wherein at least one of the magnetic layer and the cap layer is formed from a plurality of layers.

18. A recording medium according to claim 15, wherein the magnetic recording layer has a thickness of 8 to 14 nm, the exchange coupling layer has a thickness of 0.5 to 1.2 angstroms, and the cap layer has a thickness of 3 to 7 nm.

19. A recording medium according to claim 15, wherein the magnetic recording layer contains a non-metallic segregant.

20. A recording medium for perpendicular recording applications, comprising:
a magnetic recording layer comprising CoPtCrO and having a surface and an axis of magnetic anisotropy substantially perpendicular to the surface;
a first exchange coupling layer formed on the magnetic recording layer;
a high moment cap layer of CoPtCr formed on the first exchange coupling layer, and ferromagnetically exchange coupled to the magnetic recording layer;
a second exchange coupling layer formed on the high moment cap layer;
a low moment cap layer of CoPtCrB formed on the second exchange coupling layer, the exchange coupling layers regulating the ferromagnetic exchange coupling between the magnetic recording layer and the cap layers; and
the magnetic recording layer, cap layers and exchange coupling layers form a discrete track media where exchange interaction between adjacent tracks thereof is suppressed.

21. A recording medium according to claim 20, wherein each of the exchange coupling layers has a thickness of about 0.5 angstroms.

22. A recording medium according to claim 20, wherein the magnetic recording layer has a thickness of about 14 nm, each of the cap layers has a thickness of about 2 nm, and further comprising an overcoat on the cap layer.

23. A method of forming a weak-link media structure, comprising:
(a) providing a media structure having a magnetic recording layer, a cap layer and a thin interlayer boundary region between the magnetic recording layer and the cap layer;
(b) configuring the thin interlayer boundary region without an exchange coupling layer; and
(c) mediating interlayer exchange coupling between the magnetic recording and cap layers by varying a composition of a magnetic alloy in the thin interlayer boundary region.

24. A method according to claim 23, wherein step (b) comprises configuring the thin interlayer boundary region with a thickness of approximately 1 nm.

25. A method according to claim 23, wherein step (c) comprises varying an oxygen composition of the magnetic alloy in the thin interlayer boundary region.
